(19) United States
(12) Patent Application Publication
(10) Pub. No.: US 2008/0268361 A1
(43) Pub. Date: Oct. 30, 2008

(54) IMAGE FORMING APPARATUS, PROCESS CARTRIDGE, AND IMAGE FORMING METHOD

(76) Inventor: Nobuo KIKUCHI, Tokyo (JP)

Correspondence Address: OBLON, SPIVAK, MCCLELLAND MAIER & NEUSTADT, P.C., 1940 DUKE STREET, ALEXANDRIA, VA, 22314, US

(21) Appl. No.: 12/109,037

(22) Filed: Apr. 24, 2008

(30) Foreign Application Priority Data
Apr. 27, 2007 (JP) 2007-119528

(51) Int. Cl. G03G 13/06; G03G 15/02

(52) U.S. Cl. 430/97; 399/100

(57) ABSTRACT

An image forming apparatus includes an image carrier and a charging device. The image carrier supplied with a lubricant carries an electrostatic latent image and a toner image formed by making the electrostatic latent image visible with toner including toner particles and inorganic fine particles. The charging device uniformly charges a surface of the image carrier without contacting the image carrier to form the electrostatic latent image on the image carrier. The toner particles have a volume average particle size in a range of from about 3 μm to about 8 μm, a ratio Dv/Dn between a volume average particle size Dv and a number average particle size Dn in a range of from about 1.00 to about 1.40, a shape factor SF-1 in a range of from about 100 to about 180, and a shape factor SF-2 in a range of from about 100 to about 180.

### CROSS-REFERENCE TO RELATED APPLICATION

The present application is based on and claims priority to Japanese Patent Application No. 2007-119528, filed on Apr. 27, 2007 in the Japan Patent Office, the entire contents of which are hereby incorporated herein by reference.

### BACKGROUND OF THE INVENTION

1. Field of the Invention

Exemplary aspects of the present invention relate to an image forming apparatus, a process cartridge, and an image forming method, and more particularly, to an image forming apparatus, a process cartridge included in the image forming apparatus, and an image forming method for charging an image carrier.

2. Description of the Related Art

A related-art image forming apparatus, such as a copier, a facsimile machine, a printer, or a multifunction printer having at least one of copying, printing, scanning, and facsimile functions, forms a toner image on a recording medium (e.g., a transfer sheet) according to image data by electrophotography. For example, a charger charges a surface of a photoconductor. An optical writer emits a light beam onto the charged surface of the photoconductor to form an electrostatic latent image on the photoconductor according to image data. A development device develops the electrostatic latent image with a developer (e.g., toner) to form a toner image on the photoconductor. The toner image is transferred from the photoconductor onto a transfer sheet. A cleaner cleans the surface of the photoconductor after the toner image is transferred from the photoconductor. A fixing device applies heat and pressure to the transfer sheet bearing the toner image to fix the toner image on the transfer sheet. Thus, the toner image is formed on the transfer sheet.

Currently, there is market demand for an image forming apparatus capable of forming a toner image having high definition and resolution. To cope with such demand, toner particles contained in toner serving as a developer may have a small average particle size of 5 μm or less. When such small toner particles are smoothly supplied to an electrostatic latent image formed on the photoconductor, the toner particles do not adhere to areas other than the electrostatic latent image. Accordingly, a toner image precisely corresponding to the electrostatic latent image may be formed.

On the other hand, small toner particles require a better cleaner or cleaning function to remove residual particles from the photoconductor after the toner image is transferred. For example, a lubricant may be applied to the surface of the photoconductor or added to the toner. When the lubricant is applied to the surface of the photoconductor, residual small toner particles may be prevented from slipping through the cleaner, thereby effectively removing even small-diameter residual toner particles from the photoconductor.

Generally, the toner includes inorganic fine particles having an average particle size in a range of from about 50 nm to about 500 nm. The inorganic fine particles form proper spaces between toner particles contained in the toner and the photoconductor or the charger. The inorganic fine particles uniformly contact the toner particles, the photoconductor, or the charger at a small contact area, decreasing an adhering force of the toner particles and thereby facilitating development of an electrostatic latent image into a toner image and transfer of the toner image.

However, the inorganic fine particles may adhere to the lubricant applied to the surface of the photoconductor, and consequently may slip through the cleaner and adhere to the charger provided downstream from the cleaner in a direction of rotation of the photoconductor. Even a small amount of inorganic fine particles slipping through the cleaner can cause problems, because the particles gradually accumulate on the charger, degrading charging performance of the charger over time. This degradation over time in the performance of the charger is especially noticeable in a high-speed image forming apparatus in which the charger is replaced with a new one after printing is performed on a large volume of transfer sheets, for example, hundreds of thousands of transfer sheets.

Obviously, such degradation in charging performance of the charger is undesirable, and accordingly, there is a need for a technology to minimize or eliminate such degradation.

### BRIEF SUMMARY OF THE INVENTION

This specification describes below an image forming apparatus according to an exemplary embodiment of the present invention. In one exemplary embodiment of the present invention, the image forming apparatus includes an image carrier and a charging device. A lubricant is applied to the image carrier, which is configured to carry an electrostatic latent image and a toner image formed by making the electrostatic latent image visible with toner including toner particles and inorganic fine particles. The toner particles have a volume average particle size in a range of from about 3 μm to about 8 μm, a ratio Dv/Dn between a volume average particle size Dv and a number average particle size Dn in a range of from about 1.00 to about 1.40, a shape factor SF-1 in a range of from about 100 to about 180, and a shape factor SF-2 in a range of from about 100 to about 180. The charging device is configured to uniformly charge a surface of the image carrier without contacting the image carrier so that the electrostatic latent image is formed on the image carrier.

This specification further describes below a process cartridge according to an exemplary embodiment of the present invention. In one exemplary embodiment of the present invention, the process cartridge is attachable to and detachable from an image forming apparatus, and includes an image carrier and a charging device. The image carrier is supplied with a lubricant and is configured to carry an electrostatic latent image and a toner image formed by making the electrostatic latent image visible with toner including toner particles and inorganic fine particles. The charging device is configured to uniformly charge a surface of the image carrier without contacting the image carrier so that the electrostatic latent image is formed on the image carrier. The toner particles have a volume average particle size in a range of from about 3 μm to about 8 μm, a ratio Dv/Dn between a volume average particle size Dv and a number average particle size Dn in a range of from about 1.00 to about 1.40, a shape factor SF-1 in a range of from about 100 to about 180, and a shape factor SF-2 in a range of from about 100 to about 180.

This specification further describes below an image forming method according to an exemplary embodiment of the present invention. In one exemplary embodiment of the present invention, the image forming method includes applying a lubricant to a surface of an image carrier, and uniformly charging the surface of the image carrier with a charging device not contacting the image carrier to form an electrostatic latent image on the image carrier. The method further includes making the electrostatic latent image visible with toner including toner particles and inorganic fine particles. The toner particles have a volume average particle size in a range of from about 3 μm to about 8 μm, a ratio Dv/Dn between a volume average particle size Dv and a number average particle size Dn in a range of from about 1.00 to about 1.40, a shape factor SF-1 in a range of from about 100 to about 180, and a shape factor SF-2 in a range of from about 100 to about 180.

### BRIEF DESCRIPTION OF THE DRAWINGS

A more complete appreciation of the invention and the many attendant advantages thereof will be readily obtained as the same becomes better understood by reference to the following detailed description when considered in connection with the accompanying drawings, wherein:

FIG. 1 is a schematic view of an image forming apparatus according to an exemplary embodiment of the present invention;

FIG. 2 is a sectional view of a process cartridge according to an exemplary embodiment of the present invention;

FIG. 3 is a schematic view of an image forming apparatus including the process cartridge shown in FIG. 2 according to another exemplary embodiment of the present invention;

FIG. 4 is an illustration of a toner particle for explaining a shape factor SF-1;

FIG. 5 is an illustration of a toner particle for explaining a shape factor SF-2;

FIG. 6A is a sectional view of a charger included in the image forming apparatus shown in FIG. 1 or the process cartridge shown in FIG. 2 in a longitudinal direction of the charger;

FIG. 6B is a sectional view of the charger shown in FIG. 6A in a direction perpendicular to the longitudinal direction of the charger;

FIG. 7A is a plane view of the charger shown in FIG. 6A including a wire cleaner moving in a forward direction; and

FIG. 7B is a plane view of the charger shown in FIG. 7A including the wire cleaner moving in a backward direction.

### DETAILED DESCRIPTION OF THE INVENTION

In describing exemplary embodiments illustrated in the drawings, specific terminology is employed for the sake of clarity. However, the disclosure of this specification is not intended to be limited to the specific terminology so selected and it is to be understood that each specific element includes all technical equivalents that operate in a similar manner.

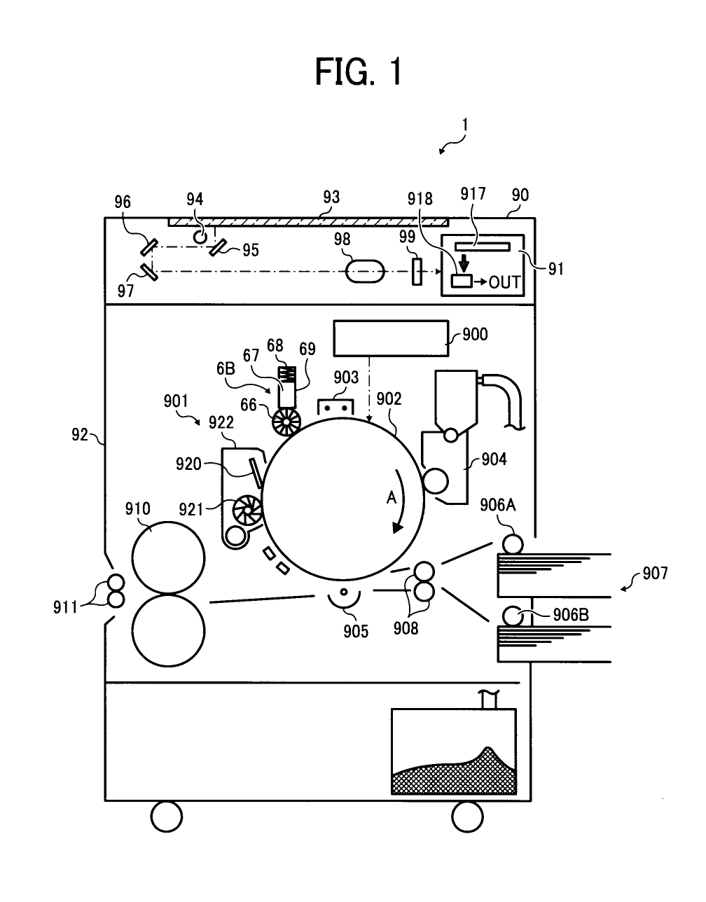

Referring now to the drawings, wherein like reference numerals designate identical or corresponding parts throughout the several views, in particular to FIG. 1, an image forming apparatus 1 according to an exemplary embodiment of the present invention is explained.

As illustrated in FIG. 1, the image forming apparatus 1 includes a scanning portion 90, an image processing portion 91, and a printing portion 92. The scanning portion 90 includes an exposure glass 93, a lamp 94, mirrors 95, 96, and 97, an image forming lens 98, and a light receiver 99. The image processing portion 91 includes a system controller 917 and a buffer memory 918. The printing portion 92 includes a recording device 901, a sheet supply portion 907, feed rollers 906A and 906B, a registration roller pair 908, a fixing device 910, and an output roller pair 911. The recording device 901 includes a laser beam emitter 900, a photoconductor 902, a charger 903, a development device 904, a transfer charger 905, a cleaning unit 922, and a lubricant applier 6B. The cleaning unit 922 includes a cleaning blade 920 and a brush roller 921. The lubricant applier 6B includes a molded lubricant 67, an applying roller 66, a spring 68, and a molded lubricant case 69.

The image forming apparatus 1 can be a copier, a facsimile machine, a printer, a plotter, a multifunction printer having at least one of copying, printing, scanning, plotter, and facsimile functions, or the like. According to this non-limiting exemplary embodiment of the present invention, the image forming apparatus 1 functions as a copier for forming an image on a recording medium by electrophotography.

The scanning portion 90 scans an image on an original document and outputs an image signal as a digital signal to the image processing portion 91. The image processing portion 91 electrically processes the image signal into image data and outputs the image data to the printing portion 92. The printing portion 92 forms an image on a recording medium (e.g., a transfer sheet) according to the image data.

In the scanning portion 90, the lamp 94 (e.g., a fluorescent lamp) emits light onto an original document placed on the exposure glass 93. The mirrors 95, 96, and 97 reflect light reflected by the original document toward the image forming lens 98. The reflected light passes through the image forming lens 98 and enters the light receiver 99, such as a CCD (charge-coupled device), as image light. The light receiver 99 converts the image light into a digital signal and outputs the digital signal to the image processing portion 91. The image processing portion 91 performs processing to convert the digital signal into an image forming signal, and outputs the image forming signal to the printing portion 92.

In the printing portion 92, the laser beam emitter 900 receives the image forming signal output by the image processing portion 91. The photoconductor 902 (e.g., a photoconductive drum) serves as an image carrier and rotates in a direction of rotation A. The charger 903, the development device 904, and the transfer charger 905 are provided around the photoconductor 902. The charger 903, serving as a charging device, is provided close to the photoconductor 902 and uniformly charges a surface of the photoconductor 902.

The laser beam emitter 900 emits a laser beam onto the charged surface of the photoconductor 902 at an exposure position on the photoconductor 902 to form an electrostatic latent image on the photoconductor 902. The development device 904 develops the electrostatic latent image with toner to form a visible toner image on the photoconductor 902.

The sheet supply portion 907 includes two paper cassettes or trays, for example, for loading a recording medium (e.g., transfer sheets). The feed roller 906A or 906B feeds a transfer sheet from one of the two paper cassettes or trays toward the registration roller pair 908. The registration roller pair 908 aligns a foremost edge of the transfer sheet and feeds the transfer sheet to a transfer position on the photoconductor 902 at a proper time. At the transfer position, the transfer charger 905 transfers the toner image formed on the photoconductor 902 onto the transfer sheet fed by the registration roller pair 908. The fixing device 910 fixes the toner image on the transfer sheet, and feeds the transfer sheet bearing the fixed toner image toward the output roller pair 911. The output roller pair 911 outputs the transfer sheet bearing the fixed toner image to an outside of the image forming apparatus 1.

In the image processing portion 91, the system controller 917 controls modules of the scanning portion 90, the image processing portion 91, and the printing portion 92, respectively. In the scanning portion 90, the lamp 94 scans an original document bearing an image at a scanning speed corresponding to a scaling rate specified by a start signal output by the system controller 917. The light receiver 99 reads the image on the original document sent through an optical system, that is, the mirrors 95, 96, and 97 and the image forming lens 98, and sends the read image to the image processing portion 91 as image data.

The image processing portion 91 performs image processing on the image data sent by the light receiver 99 of the scanning portion 90, and sends the processed image data to the printing portion 92. The image processing portion 91 also performs editing processing, such as scaling, masking, cropping, and mirroring, according to a command sent by the system controller 917. The buffer memory 918 is controlled by the system controller 917 and sends the image data to the laser beam emitter 900, so that the laser beam emitter 900 emits a laser beam onto the photoconductor 902 of the printing portion 92 according to the image data.

In the printing portion 92, the laser beam emitter 900 is modulated according to the image data sent by the image processing portion 91. Thus, a toner image is formed on a transfer sheet by electrophotographic processes.

The charger 903 is provided near the photoconductor 902 and charges the surface of the photoconductor 902 using a corotron method prior to an exposure process. The charger 903, serving as a charging device, includes a charging wire stretched in a main scanning direction of the photoconductor 902 and supplied with a high voltage. The charging wire includes a thin metal wire, such as a tungsten wire manufactured by plating or spattering gold or platinum to have a film thickness of from about 0.1 μm to about 1.5 μm. According to this exemplary embodiment, the charger 903 uses the corotron method as a corona discharging method. Alternatively, the charger 903 may use a scorotron method as a corona discharging method. In the scorotron method, a grid is provided between the charging wire and the photoconductor 902 to control a charging potential by adjusting a voltage of the grid.

The cleaning unit 922 is provided downstream from the transfer charger 905 in the direction of rotation A of the photoconductor 902. The lubricant applier 6B is provided downstream from the cleaning unit 922 in the direction of rotation A of the photoconductor 902, and applies a lubricant to the photoconductor 902. The molded lubricant 67 is formed in a rectangular parallelepiped shape and is held by the molded lubricant case 69. The applying roller 66 contacts and scrapes the molded lubricant 67 to apply a scraped lubricant to the surface of the photoconductor 902. The spring 68 presses the molded lubricant 67 toward the applying roller 66 with a predetermined pressure. Alternatively, a spindle may be attached to the molded lubricant 67 so that a weight of the molded lubricant 67 presses the molded lubricant 67 toward the applying roller 66.

The lubricant applier 6B may be provided in the cleaning unit 922 and the brush roller 921 for collecting toner particles may also serve as an applying roller for applying a lubricant to the photoconductor 902, as described below.

For example, the molded lubricant 67 may include fatty acid metal salts, such as lead oleate, zinc oleate, copper oleate, zinc stearate, cobalt stearate, iron stearate, copper stearate, zinc palmitate, copper palmitate, and zinc linoleate.

The applying roller 66 includes a material obtained by adding a resistance control material (e.g., carbon black) to a resin (e.g., nylon and acryl) and adjusting the obtained material to have a volume resistivity of from about 1×10³ Ω·cm to about 1×10⁸ Ω·cm.

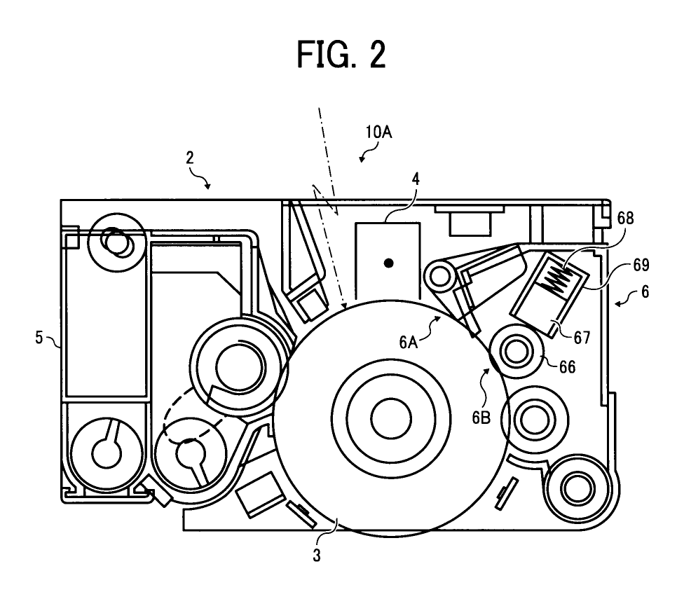

FIG. 2 is a schematic sectional view of a process cartridge 10A. The process cartridge 10A includes a casing 2, a photoconductor 3, a charger module 4, a development module 5, and a cleaning module 6. The cleaning module 6 includes the lubricant applier 6B and a cleaner 6A.

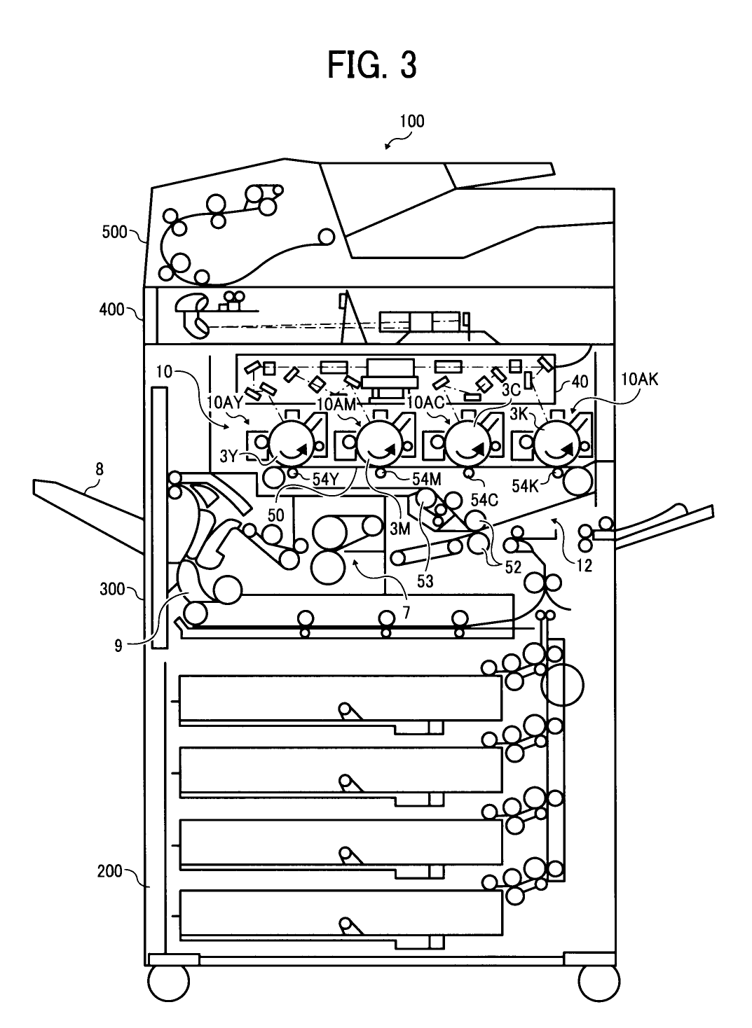

FIG. 3 is a schematic view of an image forming apparatus 100. The image forming apparatus 100 includes an image forming portion 300, a sheet supply portion 200, an original document reading portion 400, and an original document conveyance portion 500. The image forming portion 300 includes an image forming unit 10, an exposure device 40, a transfer device 12, a fixing device 7, a duplex-reverse unit 9, and an output tray 8. The image forming unit 10 includes process cartridges 10AY, 10AM, 10AC, and 10AK. The process cartridges 10AY, 10AM, 10AC, and 11AK include photoconductors 3Y, 3M, 3C, and 3K, respectively. The transfer device 12 includes first transfer members 54Y, 54M, 54C, and 54K, an intermediate transfer belt 50, a second transfer device 52, and a belt cleaner 53.

As illustrated in FIG. 2, the process cartridge 10A includes the lubricant applier 6B provided in the cleaning module 6. The photoconductor 3 serving as an image carrier, the charger module 4 serving as a charger or a charging device, the development module 5 serving as a development device, and the cleaning module 6 serving as a cleaner or a cleaning unit are provided in the casing 2. The process cartridge 10A may be attachable to and detachable from the image forming apparatus 100 (depicted in FIG. 3) so as to be replaced by a new one. When the process cartridge 10A is detached from the image forming apparatus 100, the photoconductor 3, the charger module 4, the development module 5, and the cleaning module 6 may be replaced with new ones, respectively, by a service engineer or a user. According to this exemplary embodiment, the photoconductor 3, the charger module 4, the development module 5, and the cleaning module 6 are independently provided as modules, respectively. Alternatively, the photoconductor 3, the charger module 4, the development module 5, and the cleaning module 6 may be integrally provided such that the photoconductor 3, the charger module 4, the development module 5, and the cleaning module 6 are attached to the casing 2 directly.

The lubricant applier 6B is provided in the cleaning module 6. The applying roller 66 contacts and scrapes the molded lubricant 67 to apply a scraped lubricant to a surface of the photoconductor 3. The spring 68 presses the molded lubricant 67 toward the applying roller 66 with a predetermined pressure. The molded lubricant case 69 guides the molded lubricant 67.

According to this exemplary embodiment, the lubricant applier 6B is provided in the cleaning module 6 together with the cleaner 6A. Alternatively, the lubricant applier 6B may be separately provided from the cleaner 6A. For example, the lubricant applier 6B may be an independent module replaceable separately from the cleaner 6A.

As illustrated in FIG. 3, the image forming apparatus 100 includes a plurality of process cartridges, that is, the process cartridges 10AY, 10AM, 10AC, and 10AK, and functions as a color copier for forming a color image on a recording medium (e.g., a transfer sheet) by electrophotography. The process cartridges 10AY, 10AM, 10AC, and 10AK are arranged parallel to each other and form yellow, magenta, cyan, and black toner images, respectively. The photoconductors 3Y, 3M, 3C, and 3K are provided in a center of the process cartridges 10AY, 10AM, 10AC, and 10AK, respectively.

The original document conveyance portion 500 conveys an original document to the original document reading portion 400. The original document reading portion 400 reads an image on the original document to generate image data and sends the image data to the image forming portion 300. In the image forming portion 300, the exposure device 40 converts the image data sent by the original document reading portion 400 or an external device (not shown), such as a personal computer, into an image signal. A polygon motor (not shown) scans laser beams and the laser beams irradiate the photoconductors 3Y, 3M, 3C, and 3K via mirrors (not shown) according to the image signal. Thus, electrostatic latent images are formed on the photoconductors 3Y, 3M, 3C, and 3K, respectively. Development devices (not shown) develop the electrostatic latent images with yellow, magenta, cyan, and black toner, respectively.

The first transfer members 54Y, 54M, 54C, and 54K (e.g., rollers) oppose the photoconductors 3Y, 3M, 3C, and 3K via the intermediate transfer belt 50. A power source (not shown) is connected to the first transfer members 54Y, 54M, 54C, and 54K. When a voltage is applied to the first transfer members 54Y, 54M, 54C, and 54K and an electric field is formed between the photoconductors 3Y, 3M, 3C, and 3K and the intermediate transfer belt 50, the yellow, magenta, cyan, and black toner images formed on the photoconductors 3Y, 3M, 3C, and 3K, respectively, are electrostatically transferred onto the intermediate transfer belt 50.

The intermediate transfer belt 50 has an endless belt shape and carries the yellow, magenta, cyan, and black toner images transferred from the photoconductors 3Y, 3M, 3C, and 3K, respectively, and superimposed on the intermediate transfer belt 50. The superimposed toner images form a color toner image and the color toner image is transferred onto a transfer sheet.

The intermediate transfer belt 50 includes a base layer (not shown) and an elastic layer (not shown). The base layer includes a material which may not be easily elongated, such as a fluorocarbon resin and canvas. The elastic layer is formed on the base layer, and includes a fluorocarbon rubber and an acrylonitrile-butadiene copolymer rubber. A smooth coat layer, which is produced by coating a fluorocarbon resin on the elastic layer, covers a surface of the elastic layer. The intermediate transfer belt 50 is looped over a plurality of support rollers and rotates clockwise. Alternatively, the image forming apparatus 100 may include a transfer-convey belt instead of the intermediate transfer belt 50. In this case, the transfer-convey belt conveys a transfer sheet, and yellow, magenta, cyan, and black toner images formed on the photoconductors 3Y, 3M, 3C, and 3K, respectively, are directly transferred onto the transfer sheet conveyed on the transfer-convey belt.

The second transfer device 52 (e.g., rollers) sandwiches the intermediate transfer belt 50. The second transfer device 52 transfers the color toner image formed on the intermediate transfer belt 50 onto a transfer sheet fed from the sheet supply portion 200.

The belt cleaner 53 removes residual toner particles remaining on a surface of the intermediate transfer belt 50 after the color toner image formed on the intermediate transfer belt 50 is transferred onto the transfer sheet.

The fixing device 7 is provided downstream from the second transfer device 52 in a conveyance direction of the transfer sheet. The fixing device 7 includes a belt and a pressing roller (not shown). The belt is looped over a roller (not shown) inside which a halogen heater (not shown) is provided. The belt and the pressing roller form a nip at which the belt and the pressing roller apply heat and pressure to the transfer sheet bearing the color toner image so as to fix the color toner image on the transfer sheet. Alternatively, a pair of rollers or a pair of belts may form a nip at which the pair of rollers or the pair of belts applies heat and pressure to a transfer sheet bearing a color toner image. The transfer sheet bearing the fixed color toner image is output onto the output tray 8.

To form a color toner image on another side of the transfer sheet, the duplex-reverse unit 9 reverses the transfer sheet and conveys the reversed transfer sheet toward the second transfer device 52.

The following describes toner used in the image forming apparatuses 1 (depicted in FIG. 1) and 100 (depicted in FIG. 3). The toner may preferably include toner particles having a volume average particle size in a range of from about 3 μm to about 8 μm to reproduce minute dots of about 600 dpi or more. A ratio Dv/Dn between a volume average particle size Dv and a number average particle size Dn may preferably be in a range of from about 1.00 to about 1.40. The closer to 1.00 the ratio Dv/Dn is, the sharper a particle size distribution is. Toner particles having a small particle size and a narrow particle size distribution provide a uniform charge amount distribution. Accordingly, toner particles may not adhere to a non-image area on a transfer sheet, and a high-quality toner image may be formed on the transfer sheet. When such toner particles are used in an image forming apparatus using an electrostatic transfer method, an increased transfer rate may be provided.

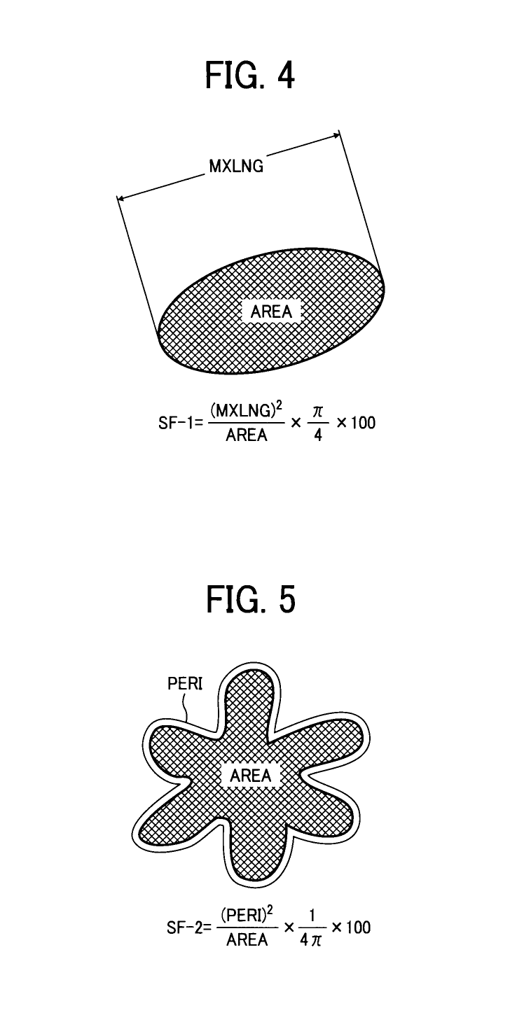

The toner particles may preferably have a shape factor SF-1 in a range of from about 100 to about 180 and a shape factor SF-2 in a range of from about 100 to about 180. FIGS. 4 and 5 illustrate typical shapes of toner particles for explaining the shape factor SF-1 and the shape factor SF-2, respectively. The shape factor SF-1 indicates a degree of roundness of a toner particle shape, and is represented by a following formula (1).

SF-1={(MXLNG)²/AREA}×(100π/4) (1)

In the above formula (1), “MXLNG” represents a maximum length of a shape of a toner particle projected on a two-dimensional plane surface. “AREA” represents an area of the projected shape of the toner particle. The shape factor SF-1 is calculated by squaring the maximum length MXLNG, dividing the squared value by the area AREA, and multiplying the divided value by “100π/4”. When the shape factor SF-1 is 100, the toner particle has a spherical shape. The greater the shape factor SF-1 is, the more amorphous shape the toner particle has.

The shape factor SF-2 indicates a degree of irregularities (e.g., projections and depressions) of a toner particle shape, and is represented by a following formula (2).

SF-2={(PERI)²/AREA}×(100/4π) (2)

In the above formula (2), “PERI” represents a circumferential length of a shape of a toner particle projected on a two-dimensional plane surface. “AREA” represents an area of the projected shape of the toner particle. The shape factor SF-2 is calculated by squaring the circumferential length PERI, dividing the squared value by the area AREA, and multiplying the divided value by “100/4π”. When the shape factor SF-2 is 100, the toner particle does not have surface irregularities. The greater the shape factor SF-2 is, the greater surface irregularities the toner particle has.

The shape factor SF-1 and the shape factor SF-2 were measured by taking a photograph of a toner particle with a scanning electron microscope S-800 manufactured by Hitachi, Ltd., analyzing the photographed toner particle with an image analyzer LUSEX3 manufactured by NIRECO Corporation, and calculating based on an analysis result.

When a toner particle has a shape close to a sphere, toner particles point-contact each other or a toner particle point-contacts a photoconductor (e.g., the photoconductor 902 depicted in FIG. 1, the photoconductor 3 depicted in FIG. 2, or the photoconductor 3Y, 3M, 3C, or 3K depicted in FIG. 3). Therefore, toner particles attract each other with a decreased attracting force and a flowability of the toner particles increases. Toner particles also contact the photoconductor with a decreased attracting force and a transfer rate of the toner particles increases. When either the shape factor SF-1 or the shape factor SF-2 exceeds 180, the transfer rate may unpreferably decrease.

The following describes inorganic fine particles contained in toner used in the image forming apparatuses 1 (depicted in FIG. 1) and 100 (depicted in FIG. 3). The inorganic fine particles may have an average primary particle size (e.g., an average particle size) in a range of from about 50 nm to about 100 nm. According to the above-described exemplary embodiments, the inorganic fine particles may include inorganic compounds, such as SiO₂, TiO₂, Al₂O₃, MgO, CuO, ZnO, SnO₂, CeO₂, Fe₂O₃, BaO, CaO, K₂O, Na₂O, ZrO₂, CaO.SiO₂, K₂O (TiO₂)ₙ, Al₂O₃.2SiO₂, CaCO₃, MgCO₃, BaSO₄, MgSO₄, and SrTiO₃, preferably SiO₂, TiO₂, and Al₂O₃. Hydrophobic treatment may be performed on the above inorganic compounds by using various coupling agents, hexamethyldisilazane, dimethyldichlorosilane, and/or octyltrimethoxysilane.

Methods for adding and adhering the inorganic fine particles to surfaces of toner particles include a method for mechanically mixing toner particles and inorganic fine particles with a known mixer to adhere the toner particles to the inorganic fine particles, and a method for evenly dispersing toner particles and inorganic fine particles with a surfactant in a liquid tank, adhering the toner particles to the inorganic fine particles, and drying the toner particles and the inorganic fine particles adhered to each other.

Table 1 below shows an experimental result of a relationship among film thickness of gold or platinum, wear resistance, resistance to arc discharge and non-uniform charge, and cost saving. In Table 1, the wear resistance marked with “*1” indicates wear resistance when a wire cleaner, which cleans a charging wire of a charger and includes felt, is activated whenever an image is formed on 10,000 sheets and an image is formed on 300,000 sheets in total. When the charging wire has a film thickness of gold or platinum of 0.08 μm as shown in Example 1, gold or platinum on a surface of the charging wire is worn and a surface of tungsten provided below gold or platinum is exposed. The resistance to arc discharge and non-uniform charge marked with “*2” indicates whether or not arc discharge is generated when an image is formed on 300,000 sheets and whether or not non-uniform charge is generated as non-uniform density in a sub-scanning direction (e.g., a sheet conveyance direction) when a uniform halftone image is formed on sheets.

TABLE 1

| | | Wear | Resistance to arc | |
|---|---|---|---|---|
| | Film | resistance | discharge and non- | Cost |
| | thickness | *1 | uniform charge *2 | saving |
| Example 1 | 0.08 μm | NO | YES | YES |
| Example 2 | 0.6 μm | YES | YES | YES |
| Example 3 | 1.8 μm | YES | YES | NO |

Table 2 below shows an experimental result of a relationship among charging wire diameter, mechanical strength, and resistance to arc discharge and non-uniform charge. In Table 2, the mechanical strength marked with “*1” indicates whether or not a charging wire installed in a charger is broken when a tension of 3 N is intermittently applied for 1,000 times. The resistance to arc discharge and non-uniform charge marked with “*2” indicates whether or not arc discharge is generated when an image is formed on 300,000 sheets and whether or not non-uniform charge is generated as non-uniform density in a sub-scanning direction (e.g., a sheet conveyance direction) when a uniform halftone image is formed on sheets.

TABLE 2

| | | | Resistance to arc |
|---|---|---|---|
| | Charging wire | Mechanical | discharge and non- |
| | diameter | strength *1 | uniform charge *2 |
| Example 1 | 25 μm | Not good | YES |
| Example 2 | 60 μm | Good | YES |
| Example 3 | 130 μm | Good | NO |

According to the above-described exemplary embodiments, even when an amount of inorganic fine particles on a photoconductor (e.g., the photoconductor 902 depicted in FIG. 1, the photoconductor 3 depicted in FIG. 2, or the photoconductor 3Y, 3M, 3C, or 3K depicted in FIG. 3) is increased after a cleaner (e.g., the cleaning unit 922 depicted in FIG. 1 or the cleaning module 6 depicted in FIG. 2) removes toner particles from a surface of the photoconductor after a toner image is transferred from the photoconductor onto a transfer sheet or the intermediate transfer belt 50 (depicted in FIG. 3), the inorganic fine particles may not directly affect a charger (e.g., the charger 903 depicted in FIG. 1 or the charger module 4 depicted in FIG. 2). Thus, the inorganic fine particles may not degrade charging performance of the charger. As a result, a high-quality image may be formed on the transfer sheet.

However, discharging performed by the charger may decrease an adhering force for adhering the inorganic fine particles to the photoconductor. Consequently, the inorganic fine particles may separate from the photoconductor due to the decreased adhering force, a centrifugal force caused by rotation of the photoconductor, and airflow in the charger. When the separated inorganic fine particles adhere to a charging wire of the charger, the inorganic fine particles may cause the charger to non-uniformly charge the surface of the photoconductor as more and more inorganic fine particles adhere to the charging wire. This problem may easily occur when the charging wire is formed of a tungsten wire molded into a wire shape by drawing a material.

The amount of inorganic fine particles adhered to the charging wire varies depending on smoothness of a surface of the charging wire. For example, floating inorganic fine particles easily adhere to minute, micron-sized projections and depressions (e.g., a damaged portion caused by processing and a micro crack) formed on the surface of the charging wire by processing. On the other hands, a charging wire manufactured by plating or spattering gold or platinum, in which tungsten is generally used as an elemental wire, provides a smooth surface without a damaged portion caused by processing and a micro crack. Floating inorganic fine particles may not easily adhere to such smooth surface of the charging wire. Accordingly, a decreased amount of inorganic fine particles adheres to the charging wire, preventing the photoconductor from being non-uniformly charged over time.

When gold or platinum has a small film thickness, it may provide decreased wear resistance. When gold or platinum has a too large film thickness, costs of gold or platinum may increase but such gold or platinum may not provide effects corresponding to the increased costs. Therefore, gold or platinum may preferably have a film thickness in a range of from about 0.1 μm to about 1.5 μm.

When the charging wire has a small diameter, it may provide a decreased discharging voltage. An initial discharging voltage of the charging wire is small. Therefore, even when more and more inorganic fine particles adhere to the charging wire over time and thereby the discharging voltage of the charging wire increases, arc discharge (e.g., leakage) may not easily occur partially or abruptly. However, when the charging wire has a small diameter, strength of the charging wire decreases and thereby the charging wire may be easily broken when the charging wire is installed in the charger or replaced with a new one. When the charging wire has a large diameter, strength of the charging wire increases and thereby the charging wire may not be easily broken. However, discharging voltage increases and thereby more and more inorganic fine particles adhere to the charging wire over time. Accordingly, arc discharge or non-uniform charge may easily occur partially or abruptly. When the charging wire has a diameter in a range of from about 30 μm to about 120 μm, the charging wire may provide both proper resistance to arc discharge and non-uniform charge and proper strength over time.

As described above, when the charging wire is manufactured by plating or spattering gold or platinum on the surface of the charging wire, floating inorganic fine particles may not easily adhere to the surface of the charging wire. Accordingly, increase in an amount of inorganic fine particles adhering to the charging wire may be suppressed, preventing the photoconductor from being non-uniformly charged over time.

To keep the surface of the charging wire clean, a wire cleaner for mechanically removing inorganic fine particles from the surface of the charging wire may be used. However, the charging wire including gold or platinum plated or spattered on the surface of the charging wire has a surface hardness lower than a surface hardness of a charging wire including tungsten. Accordingly, when the wire cleaner cleans the surface of the charging wire, minute, micron-sized projections and depressions (e.g., damages) may be formed on the surface of the charging wire. When inorganic fine particles having an average particle size in a range of from about 50 nm to about 500 nm adhere to the minute, micron-sized projections and depressions on the surface of the charging wire, the wire cleaner may put the inorganic fine particles into the projections and depressions. The inorganic fine particles put into the projections and depressions may cause arc discharge and non-uniform charge.

To address this problem, the wire cleaner may include a cleaning pad for cleaning the surface of the charging wire and including an abrasive-free elastic member (e.g., felt and neoprene). Thus, the wire cleaner may not form minute, micron-sized projections and depressions on the surface of the charging wire. The cleaning pad keeps the surface of the charging wire clean, preventing arc discharge and non-uniform charge over time.

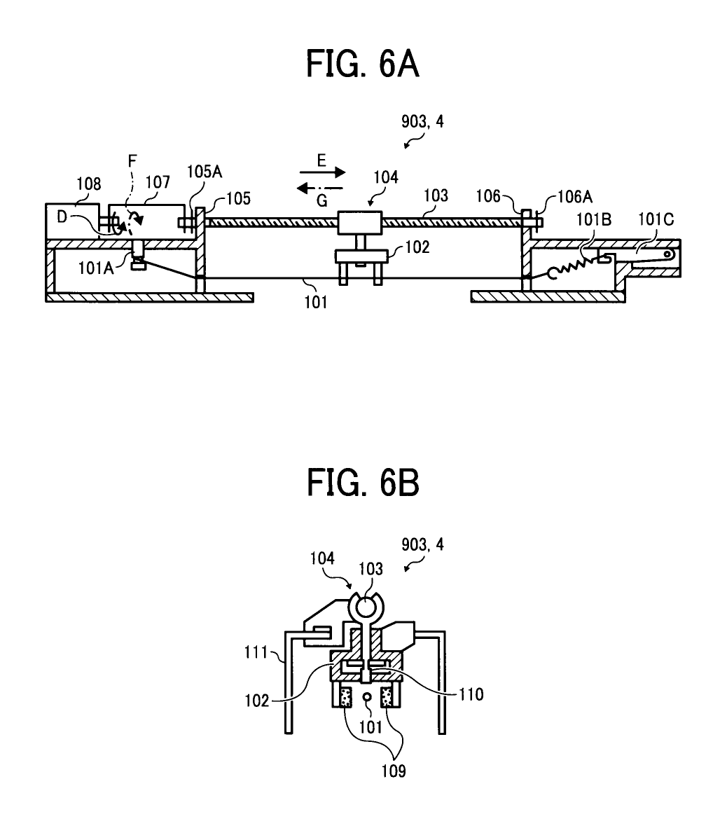

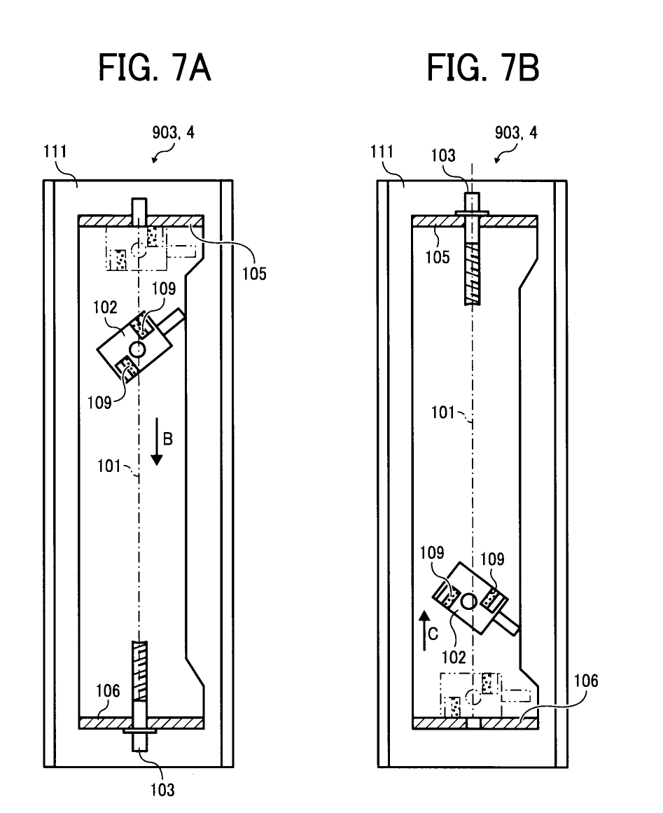

Referring to FIGS. 6A, 6B, 7A, and 7B, the following describes a wire cleaner included in the charger 903 (depicted in FIG. 1) and the charger module 4 (depicted in FIG. 2) including a single charging wire. FIG. 6A is a sectional view of the charger 903 or the charger module 4 in a longitudinal direction of the charger 903 or the charger module 4 (e.g., an axial direction of the photoconductor 902 depicted in FIG. 1 or the photoconductor 3 depicted in FIG. 2). The charger 903 or the charger module 4 includes a charging wire 101, electrodes 101A and 101C, a spring 101B, a wire cleaner 102, a male screw 103, a female screw 104, end blocks 105 and 106, rings 105A and 106A, a motor 108, and an elastic member 107.

The charging wire 101 generates corona discharge. The electrodes 101A and 101C supply an electric current to the charging wire 101 to cause the charging wire 101 to generate corona discharge. The spring 101B applies a predetermined elasticity to the charging wire 101. The wire cleaner 102 cleans the charging wire 101. The male screw 103 moves the wire cleaner 102 in a longitudinal direction of the male screw 103. The female screw 104 supports and moves the wire cleaner 102 according to rotation of the male screw 103. The end blocks 105 and 106 hold the male screw 103 and regulate a movement area of the female screw 104. The rings 105A and 106A rotatably engage with the male screw 103. The motor 108 rotatably drives the male screw 103. The elastic member 107 is provided between the motor 108 and the male screw 103 to transmit a driving force generated by the motor 108 to the male screw 103.

FIG. 6B is a sectional view of the charger 903 or the charger module 4 in a direction perpendicular to the longitudinal direction of the charger 903 or the charger module 4 (e.g., a direction perpendicular to the axial direction of the photoconductor 902 depicted in FIG. 1 or the photoconductor 3 depicted in FIG. 2). The charger 903 or the charger module 4 further includes a stopper 110 and a shield case 111. The wire cleaner 102 includes cleaning pads 109.

The cleaning pads 109 are attached to the wire cleaner 102 and clean the charging wire 101. The stopper 110 rotatably attaches the wire cleaner 102 to a shaft of the female screw 104. The shield case 111 forms a case of the charger 903 or the charger module 4.

The cleaning pads 109 for cleaning the charging wire 101 include a nonwoven fabric (e.g., an elastic member), such as felt not containing an abrasive (e.g., alumina powder, ceramic powder, cerium powder, and silica powder having a particle size in a range of from about 10 μm to about 40 μm).

FIGS. 7A and 7B illustrate a plane view of the charger 903 or the charger module 4. The shield case 111 includes an opening including wide portions near the end blocks 105 and 106, respectively. A nail of the wire cleaner 102 engages with the wide portions of the opening of the shield case 111, as illustrated in a broken line in FIG. 7A. When the wire cleaner 102 moves in a direction B, the cleaning pads 109 of the wire cleaner 102 contact the charging wire 101. When the wire cleaner 102 moves in a direction C, as illustrated in FIG. 7B, the cleaning pads 109 separate from the charging wire 101. A back-and-forth movement, that is, movement in the directions B and C, of the wire cleaner 102 cleans the charging wire 101.

When the female screw 104 (depicted in FIG. 6A) hits the end blocks 105 and 106, a value of an electric current flowing to the motor 108 (depicted FIG. 6A) increases substantially. The female screw 104 reaching the end blocks 105 and 106 is detected by the increased value of the electric current flowing to the motor 108.

Referring to FIG. 6A, the following describes operations of the charger 903 or the charger module 4 having the above-described structure. When the motor 108 rotates in a direction of rotation D, the female screw 104 moves in a direction E. When the motor 108 rotates in a direction of rotation F, the female screw 104 moves in a direction G. When the charger 903 or the charger module 4 charges the surface of the photoconductor 902 (depicted in FIG. 1) or the photoconductor 3 (depicted in FIG. 2), the female screw 104 is on standby at a position near the end block 105 or a position near the end block 106. The female screw 104 moves back and forth in the directions E and G so that the cleaning pads 109 (depicted in FIG. 6B) clean the charging wire 101, and stops at an original position near the end block 105 or 106.

A number of rotations of the motor 108 is decreased to a number needed for the female screw 104 to move between the end blocks 105 and 106. Accordingly, when the female screw 104 hits the end blocks 105 and 106, the female screw 104 may not be tightened excessively. In other words, inertial rotation energy of a drive system including the male screw 103 may not tighten the female screw 104 and the male screw 103 excessively.

Generally, in order to reduce costs, for example, a DC (direct current) motor is used as the motor 108 and a number of rotations of an output shaft of the motor 108 is decreased with a large speed reduction ratio. Thus, inertial rotation energy of the drive system may mostly generate in the output shaft of the motor 108. Therefore, kinetic energy held by the drive system after the female screw 104 hits the end block 105 or 106 until the motor 108 stops may be stored in a portion other than the drive system or discharged so as to prevent the female screw 104 from being tightened excessively.

According to the above-described exemplary embodiments, even when inorganic fine particles remain on a photoconductor (e.g., the photoconductor 902 depicted in FIG. 1, the photoconductor 3 depicted in FIG. 2, or the photoconductor 3Y, 3M, 3C, or 3K depicted in FIG. 3) after a cleaner (e.g., the cleaning unit 922 depicted in FIG. 1 or the cleaning module 6 depicted in FIG. 2) removes toner particles from a surface of the photoconductor, the inorganic fine particles may not degrade charging performance of a charger (e.g., the charger 903 depicted in FIG. 1 or the charger module 4 depicted in FIG. 2). As a result, a high-quality image may be formed on a transfer sheet.

Further, increase in an amount of inorganic fine particles adhering to a charging wire (e.g., the charging wire 101 depicted in FIG. 6A) may be suppressed. Thus, the charging performance of the charger may not degrade due to arc discharge and non-uniform charge over time, resulting in formation of a high-quality image. The charging wire may provide both proper wear resistance over time and cost saving.

A cleaning pad (e.g., the cleaning pads 109 depicted in FIG. 6B) cleans a surface of the charging wire without forming minute, micron-sized projections and depressions on the surface of the charging wire. Accordingly, arc discharge and non-uniform charge may not occur over time. Namely, charging performance of the charger may not degrade due to arc discharge and non-uniform charge over time. As a result, a high-quality image may be formed.

The present invention has been described above with reference to specific exemplary embodiments. Note that the present invention is not limited to the details of the embodiments described above, but various modifications and enhancements are possible without departing from the spirit and scope of the invention. It is therefore to be understood that the present invention may be practiced otherwise than as specifically described herein. For example, elements and/or features of different illustrative exemplary embodiments may be combined with each other and/or substituted for each other within the scope of the present invention.

What is claimed is:

1. An image forming apparatus, comprising:
an image carrier supplied with a lubricant and configured to carry an electrostatic latent image and a toner image formed by making the electrostatic latent image visible with toner including toner particles and inorganic fine particles; and
a charging device configured to uniformly charge a surface of the image carrier without contacting the image carrier to form the electrostatic latent image on the image carrier,
the toner particles having a volume average particle size in a range of from about 3 μm to about 8 μm, a ratio Dv/Dn between a volume average particle size Dv and a number average particle size Dn in a range of from about 1.00 to about 1.40, a shape factor SF-1 in a range of from about 100 to about 180, and a shape factor SF-2 in a range of from about 100 to about 180.

2. The image forming apparatus according to claim 1,
wherein the charging device includes a charger including a charging wire.

3. The image forming apparatus according to claim 2,
wherein one of gold and platinum is provided on a surface of the charging wire by one of plating and spattering.

4. The image forming apparatus according to claim 3,
wherein one of gold and platinum has a film thickness in a range of from about 0.1 μm to about 1.5 μm.

5. The image forming apparatus according to claim 3,
wherein the charging wire has a diameter in a range of from about 30 μm to about 120 μm.

6. The image forming apparatus according to claim 3,
wherein the charging device further includes a cleaning pad configured to clean the surface of the charging wire,
the cleaning pad including an abrasive-free elastic member.

7. A process cartridge detachably attachable to an image forming apparatus, the process cartridge comprising:
an image carrier supplied with a lubricant and configured to carry an electrostatic latent image and a toner image formed by making the electrostatic latent image visible with toner including toner particles and inorganic fine particles; and
a charging device configured to uniformly charge a surface of the image carrier without contacting the image carrier to form the electrostatic latent image on the image carrier,
the toner particles having a volume average particle size in a range of from about 3 μm to about 8 μm, a ratio Dv/Dn between a volume average particle size Dv and a number average particle size Dn in a range of from about 1.00 to about 1.40, a shape factor SF-1 in a range of from about 100 to about 180, and a shape factor SF-2 in a range of from about 100 to about 180.

8. The process cartridge according to claim 7,
wherein the charging device includes a charger including a charging wire.

9. The process cartridge according to claim 8,
wherein one of gold and platinum is provided on a surface of the charging wire by one of plating and spattering.

10. The process cartridge according to claim 9,
wherein one of gold and platinum has a film thickness in a range of from about 0.1 μm to about 1.5 μm.

11. The process cartridge according to claim 9,
wherein the charging wire has a diameter in a range of from about 30 μm to about 120 μm.

12. The process cartridge according to claim 9,
wherein the charging device further includes a cleaning pad configured to clean the surface of the charging wire,
the cleaning pad including an abrasive-free elastic member.

13. An image forming method, comprising the steps of:
applying a lubricant to a surface of an image carrier;
uniformly charging the surface of the image carrier with a charging device not contacting the image carrier to form an electrostatic latent image on the image carrier; and
making the electrostatic latent image visible with toner including toner particles and inorganic fine particles,
the toner particles having a volume average particle size in a range of from about 3 μm to about 8 μm, a ratio Dv/Dn between a volume average particle size Dv and a number average particle size Dn in a range of from about 1.00 to about 1.40, a shape factor SF-1 in a range of from about 100 to about 180, and a shape factor SF-2 in a range of from about 100 to about 180.

14. The image forming method according to claim 13,
wherein the charging device includes a charger including a charging wire.

15. The image forming method according to claim 14, further comprising the step of forming a surface of the charging wire by one of plating and spattering of one of gold and platinum.

16. The image forming method according to claim 15,
wherein one of gold and platinum has a film thickness in a range of from about 0.1 μm to about 1.5 μm.

17. The image forming method according to claim 15,
wherein the charging wire has a diameter in a range of from about 30 μm to about 120 μm.

18. The image forming method according to claim 15, further comprising the step of cleaning the surface of the charging wire with a cleaning pad including an abrasive-free elastic member.
